(19) United States
(12) Patent Application Publication
(10) Pub. No.: US 2012/0213949 A1
(43) Pub. Date: Aug. 23, 2012

(54) METHOD FOR PRODUCING INDIUM TIN OXIDE LAYER WITH CONTROLLED SURFACE RESISTANCE

(76) Inventors: CHIEN-MIN WENG, Tao-Yuan (TW); SHIH-LIANG CHOU, Tao-Yuan (TW); TZU-WEN CHU, Tao-Yuan (TW); FU-JEN WANG, Tao-Yuan (TW); FENG-SHIANG YAO, Tao-Yuan (TW)

(21) Appl. No.: 13/030,223

(22) Filed: Feb. 18, 2011

(51) Int. Cl. H05H 1/24

(52) U.S. Cl. 427/576

(57) ABSTRACT

The invention relates to a method for producing a transparent indium tin oxide conductive layer on a substrate. The method involves using a target having a low indium-to-tin ratio in a low temperature manufacturing process (less than 200° C.), and introducing a plasma gas and a reaction gas into the reaction chamber to allow sputtering of an indium tin oxide layer on the substrate under a low oxygen environment, followed by subjecting the sputtered substrate to a heat treatment at 150˜200° C. for 60˜90 minutes. The indium tin oxide layer thus produced will crystallize completely and have the advantageous properties of low surface resistance and high uniformity.

### BACKGROUND OF THE INVENTION

1. Field of the Invention

The present invention relates to a method for producing an indium tin oxide layer with a controlled surface resistance. The indium tin oxide (ITO) layer produced by the inventive method exhibits high uniformity and a low variance in surface resistance (Rs). All of these advantages make the ITO layer particularly suitable for use in a touch panel structure.

2. Description of the Prior Art

Transparent indium tin oxide (ITO) conductive layers continue to increase in popularity because of their high research and economic value. They have currently been adopted in a broad variety of optoelectronic products, such as liquid crystal display panels for automobile use, touch panels, anti-electromagnetic interference glasses, liquid crystal watches, liquid crystal display panels for home electronics, solar cells, portable LCD game players, liquid crystal display devices for measurement instruments, LCD color televisions, laptop personal computers, portable personal computers, plasma display panels (PDPs), organic electroluminescent display devices, liquid crystal display devices (LCDs) and electrodes of color filters.

Owing to the growing requirements for ITO transparent conductive layers, there is an great need for an economic and efficient method for producing the same. FIG. 1 illustrates a conventional method for forming an ITO layer on a transparent substrate, such as a glass substrate. The method generally comprises the steps of subjecting the transparent substrate to a heat treatment at an elevated temperature of 200˜400° C. for 10˜30 minutes, and then subjecting the transparent substrate to an ITO sputtering treatment at the elevated temperature in a sputtering chamber, followed by quenching the sputtered substrate to form a crystallized ITO layer on the substrate.

However, the crystallized ITO layer produced by the conventional method described above is formed by performing sputtering at a high temperature and, therefore, exhibits a highly variable electric resistance value due to its susceptibility to high temperature and moisture. As a consequence, the overall uniformity across the ITO layer is much less than satisfactory. When the ITO layer is incorporated into a touch panel, a divergence in signal quality would occur during operation, resulting in a failure to precisely determine the coordinates of touch points.

In addition to using a glass substrate as a base substrate on which an ITO layer is to be deposited, efforts have been made to develop a technique of depositing an ITO layer on a flexible plastic substrate. However, given the fact that plastic substrates are vulnerable to heat, it is impossible to form a highly crystallized ITO layer at an elevated temperature of greater than 350° C. On the other hand, a low-temperature manufacturing process would obtain an ITO layer with less crystallinity, causing an undesired rise of electric resistance in the ITO layer. As such, current research in the related technical field focuses on development of a low-temperature sputtering process for depositing an ITO layer with high transparency, low electric resistance and high uniformity.

### SUMMARY OF THE INVENTION

An object of the invention is to provide a method for producing an indium tin oxide layer with a high uniformity and a low variance in surface resistance (Rs), which is particularly suitable for use in a touch screen.

In order to achieve the object described above, the method according to the invention generally comprises using a target having a low indium-to-tin ratio in a low-temperature manufacturing process (less than 200° C.), and introducing a plasma gas and a reaction gas into the reaction chamber to allow sputtering of an indium tin oxide layer on the substrate under a low oxygen environment, followed by subjecting the sputtered substrate to a heat treatment at 150˜200° C. for 60˜90 minutes. The indium tin oxide layer thus produced will crystallize completely and have the advantageous properties of low surface resistance and high uniformity.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a schematic diagram illustrating an indium tin oxide layer formed by sputtering according to the first preferred embodiment of the invention;

FIG. 2 is a diagram showing the measured values for the surface resistance (Rs) of the ITO layers after baking;

FIG. 3 is a diagram showing the measured values for the surface resistance uniformity (UNIF) of the ITO layers after baking;

FIG. 4 is a schematic diagram illustrating an indium tin oxide layer formed by sputtering according to the second preferred embodiment of the invention;

FIG. 5 is a diagram showing the measured values for the surface resistance (Rs) of the ITO layers after baking;

FIG. 6 is a diagram showing the measured values for the surface resistance uniformity (UNIF) of the ITO layers after baking; and

FIG. 7 is a diagram showing the measured values for the surface resistance (Rs) of the ITO layers after baking.

### DETAILED DESCRIPTION OF THE PREFERRED EMBODIMENTS

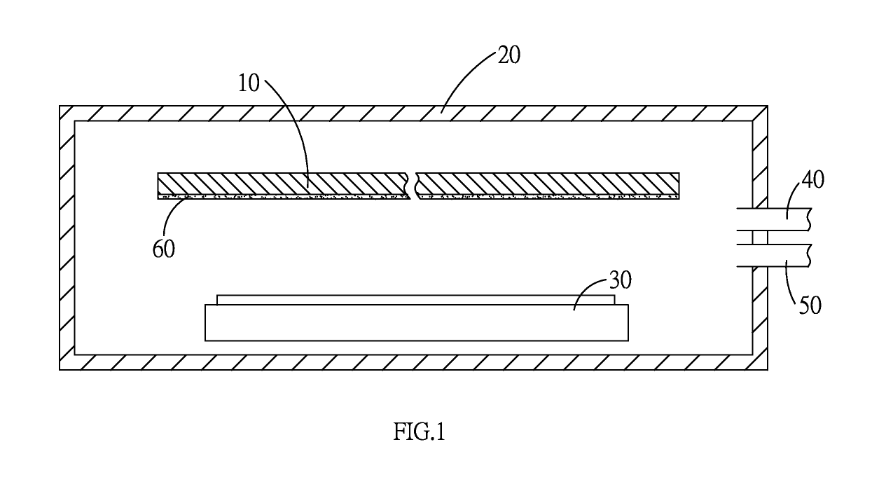

The present invention relates to a method for producing a transparent indium tin oxide conductive layer having a low value of surface resistance and a high level of uniformity. The method includes the following steps. First, as shown in FIG. 1, a substrate 10 is placed into a reaction chamber 20 of a sputtering instrument. The reaction chamber 20 is set to have a working temperature of less than 200° C. and provided inside with an indium tin oxide target 30 having a low ratio of indium oxide to tin oxide from 90%:10% by weight to 99%:1% by weight, such as a ratio of indium oxide to tin oxide from 95%:5% by weight to 97%:3% by weight. In addition, the substrate 10 may by way of example be a transparent substrate (which may be made of glass or plastic material), a thin-film transistor array substrate for a liquid crystal display device, or a substrate coated with thin films of other types.

Next, a plasma gas 40 and a reaction gas 50 are introduced into the reaction chamber 20, so that the substrate 10 is sputtered with a layer of indium tin oxide 60. The substrate 10 is maintained at a temperature of less than 200° C. throughout the deposition of the indium tin oxide layer 60. The plasma gas 40 may by way of example be argon or other inert gas. It should be noted that the reaction gas comprises at least oxygen in an amount of about 0.8%˜1.5% by mole based on the total molar amount of the gas contained within the reaction chamber, so that the indium tin oxide layer 60 is formed by sputtering in a low oxygen environment.

Afterwards, the sputtered substrate is subjected to a heat treatment at a temperature of 150˜200° C. for 60˜90 minutes under an atmospheric environment, so as to allow the indium tin oxide layer 60 to crystallize completely.

Examples are given below to characterize the properties of the ITO layer formed according to the first preferred embodiment of the invention.

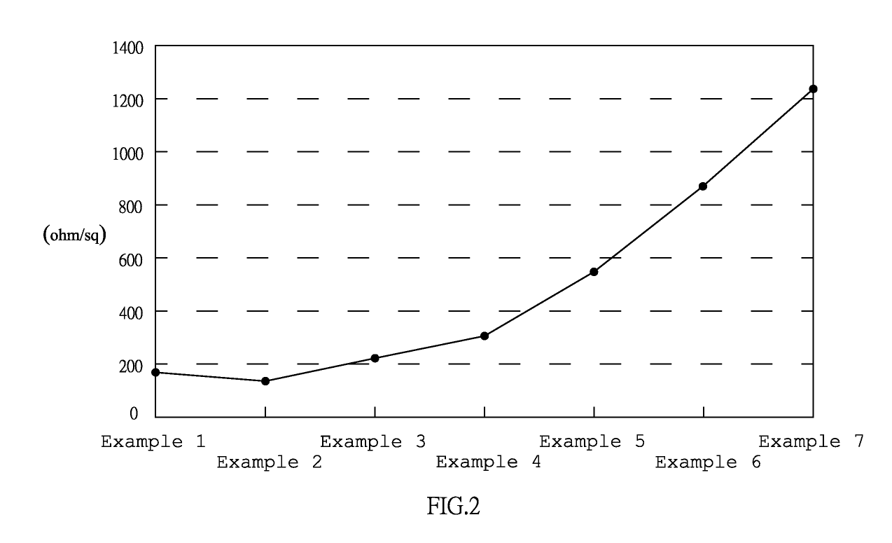

FIG. 2 is a diagram showing the measured values for the surface resistance (Rs) of the ITO layers after annealing, wherein the ordinate represents surface resistance value (in ohm/square) and the abscissa represents the serial number of Examples. The respective Examples shown in FIG. 2 are carried out under the conditions listed in Table 1 below.

TABLE 1

| | Oxygen Content |
|---|---|
| Example 1 | 0.8% |
| Example 2 | 1.1% |
| Example 3 | 1.5% |
| Example 4 | 1.8% |
| Example 5 | 2.3% |
| Example 6 | 2.8% |
| Example 7 | 3.2% |

As shown in FIG. 2, the respective Examples have a surface resistance value ranging from about 180 ohm/sq to about 1250 ohm/sq, with Examples 1˜3 exhibiting the lowest surface resistance value.

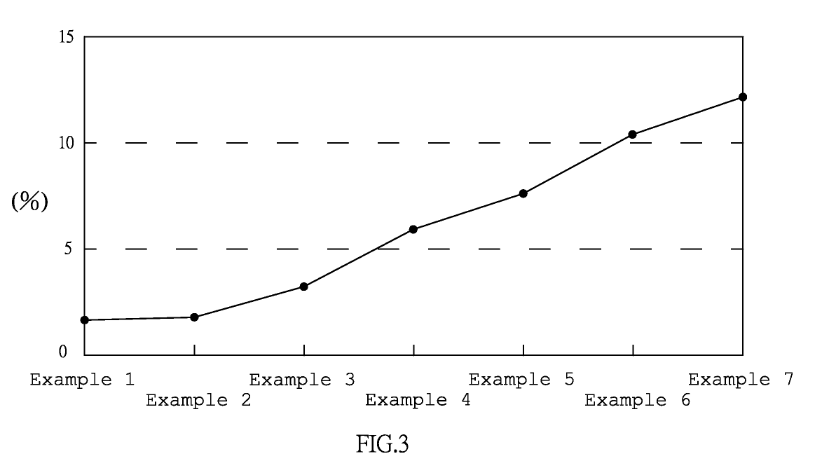

FIG. 3 is a diagram showing the measured values for the surface resistance uniformity (Rs UNIF) of the ITO layers after annealing, wherein the ordinate represents Rs uniformity (in percent) and the abscissa represents the serial number of Examples. The respective Examples shown in FIG. 3 are carried out under the conditions listed in Table 1 above.

As shown in FIG. 3, the respective Examples have a Rs uniformity value from about 2% to about 13%, with Examples 1˜3 exhibiting the greatest Rs uniformity.

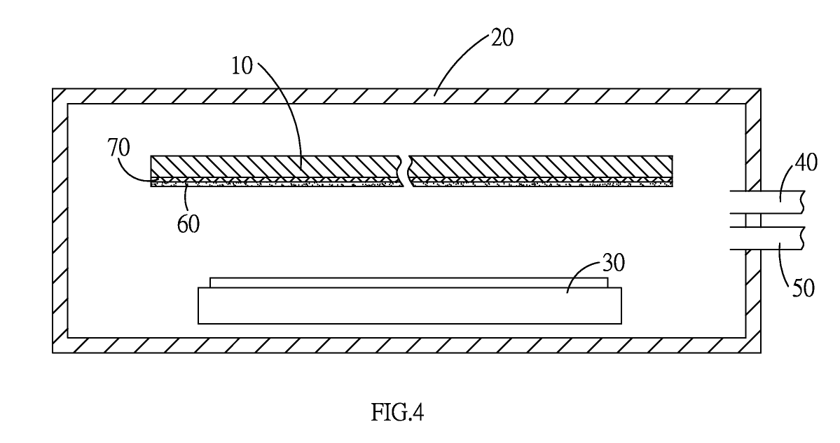

According to the second preferred embodiment of the invention, the substrate 10 is first deposited with an oxide dielectric layer 70 (which may by way of example be a silicon dioxide layer) as shown in FIG. 4. An indium tin oxide layer 60 is then deposited onto the oxide dielectric layer 70. The oxide dielectric layer 70 is formed by sputtering. During the sputtering process, oxygen is provided in an amount of 30%˜40% by mole based on the total molar amount of the gas contained in the reaction chamber, so that the oxide dielectric layer 70 is formed in a low oxygen environment. The indium tin oxide layer thus formed is imparted with a low value of surface resistance and a high level of uniformity.

Examples are given below to characterize the properties of the ITO layer formed according to the second preferred embodiment of the invention.

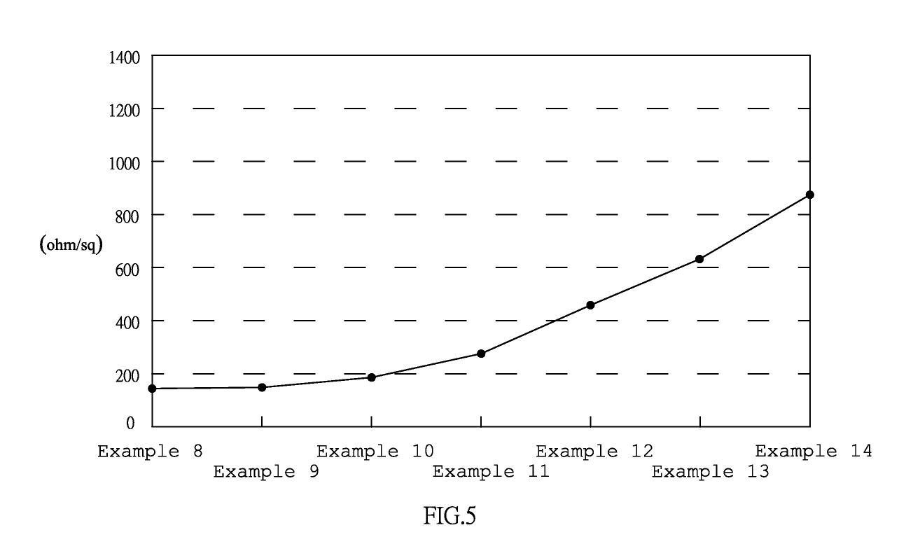

FIG. 5 is a diagram showing the measured values for the surface resistance (Rs) of the ITO layers after annealing, wherein the ordinate represents surface resistance value (in ohm/sq) and the abscissa represents the serial number of Examples. The respective Examples shown in FIG. 5 are carried out under the conditions listed in Table 2 below.

TABLE 2

| | Oxygen Content |
|---|---|
| Example 8 | 30% |
| Example 9 | 35% |
| Example 10 | 40% |
| Example 11 | 45% |
| Example 12 | 50% |
| Example 13 | 55% |
| Example 14 | 60% |

As shown in FIG. 5, the respective Examples have a surface resistance value ranging from about 160 ohm/sq to about 1000 ohm/sq, with Examples 8˜10 exhibiting the lowest surface resistance value.

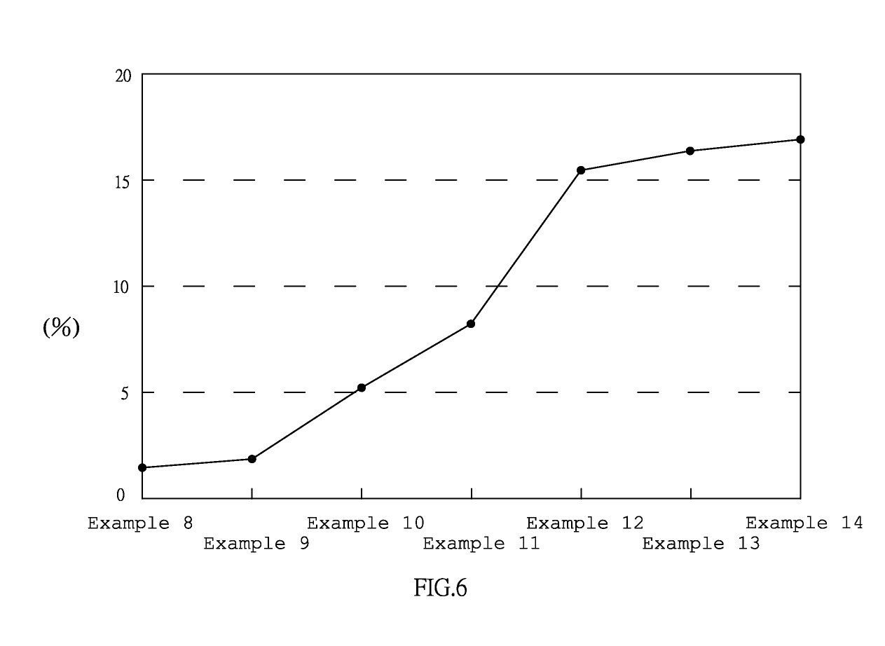

FIG. 6 is a diagram showing the measured values for the surface resistance uniformity (Rs UNIF) of the ITO layers after annealing, wherein the ordinate represents Rs uniformity (in percent) and the abscissa represents the serial number of Examples. The respective Examples shown in FIG. 6 are carried out under the conditions listed in Table 2 above.

As shown in FIG. 6, the respective Examples have a Rs uniformity value from about 2% to about 18%, with Examples 8-10 exhibiting the greatest Rs uniformity.

It can be seen from the experimental results demonstrated above that by virtue of providing a low-oxygen environment during the process of sputtering oxides (such as silicon dioxide and indium tin oxide), the invention successfully imparts the sputtered ITO layer with a low value of surface resistance and a high level of uniformity.

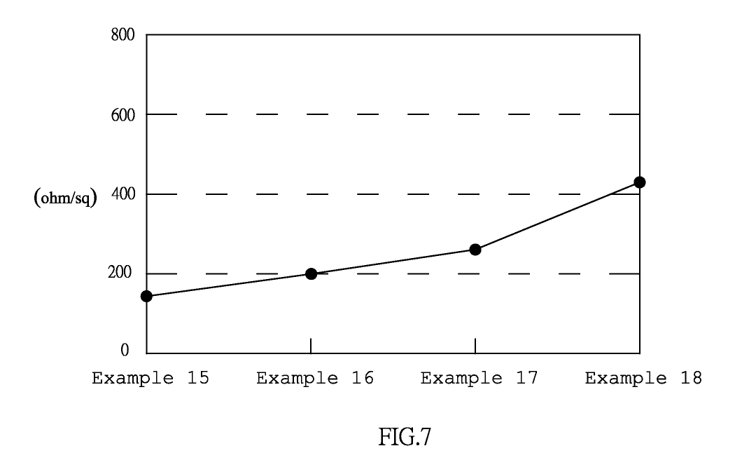

In addition, the surface resistance of an indium tin oxide layer can be further controlled by adjusting the vacuum degree within the reaction chamber of the sputtering instrument, prior to performing the sputtering process. In the case where the vacuum degree is modulated to be 2×10⁻⁶˜3×10⁻⁶ torr, the resultant indium tin oxide layer will possess an even lower value of surface resistance. FIG. 7 is a diagram showing the measured values for the surface resistance (Rs) of the ITO layers after annealing, wherein the ordinate represents surface resistance value (in ohm/sq) and the abscissa represents the serial number of Examples. The respective Examples shown in FIG. 7 are carried out under the conditions listed in Table 3 below. The amount of oxygen introduced into the reaction chamber is approximately 1.5% by mole based on the total molar amount of the gas contained in the reaction chamber.

TABLE 3

| | Pressure (torr) |
|---|---|
| Example 15 | 2.4 × 10⁻⁶ |
| Example 16 | 2.6 × 10⁻⁶ |
| Example 17 | 2.8 × 10⁻⁶ |
| Example 18 | 3.4 × 10⁻⁶ |

As demonstrated in FIG. 7, the respective Examples have a surface resistance value ranging from about 160 ohm/sq to about 450 ohm/sq, with Examples 15˜17 exhibiting the lowest surface resistance value.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit of the invention and the scope thereof as defined in the appended claims.

What is claimed is:

1. A method for producing an indium tin oxide layer with a controlled surface resistance, comprising the steps of:
A. placing a substrate into a reaction chamber, wherein the reaction chamber is set to have a working temperature of less than 200° C. and provided inside with an indium tin oxide target having a ratio of indium oxide to tin oxide from 90 wt %:10 wt % to 99 wt %:1 wt %;
B. introducing a plasma gas and a reaction gas into the reaction chamber, so that the substrate is formed with an indium tin oxide layer, wherein the reaction gas comprises at least oxygen in an amount of 0.8%˜1.5% by mole based on the total molar amount of the gas contained in the reaction chamber; and
C. subjecting the substrate obtained in Step B to a heat treatment at a temperature of 150˜200° C. for 60˜90 minutes under an atmospheric environment, so as to allow the indium tin oxide layer to crystallize completely.

2. The method for producing an indium tin oxide layer with a controlled surface resistance according to claim 1, wherein the substrate in Step A is provided with an oxide dielectric layer and the indium tin oxide layer is formed onto the oxide dielectric layer in Step B.

3. The method for producing an indium tin oxide layer with a controlled surface resistance according to claim 2, wherein the oxide dielectric layer is made of silicon dioxide.

4. The method for producing an indium tin oxide layer with a controlled surface resistance according to claim 2, wherein the oxide dielectric layer is formed by a sputtering process where oxygen is introduced in an amount of 30%˜40% by mole based on the total molar amount of the gas contained in the reaction chamber.

5. The method for producing an indium tin oxide layer with a controlled surface resistance according to claim 4, wherein the reaction chamber in Step A has a vacuum degree of 2×10⁻⁶˜3×10⁻⁶ torr.

6. The method for producing an indium tin oxide layer with a controlled surface resistance according to claim 1, wherein the plasma gas is argon.

7. The method for producing an indium tin oxide layer with a controlled surface resistance according to claim 1, wherein the reaction chamber in Step A has a vacuum degree of 2×10⁻⁶˜3×10⁻⁶ torr.

8. The method for producing an indium tin oxide layer with a controlled surface resistance according to claim 3, wherein the oxide dielectric layer is formed by a sputtering process where oxygen is introduced in an amount of 30%˜40% by mole based on the total molar amount of the gas contained in the reaction chamber.
